(19) United States
(12) Patent Application Publication
(10) Pub. No.: US 2018/0317097 A1
(43) Pub. Date: Nov. 1, 2018

(54) APPARATUS AND METHOD FOR PROVIDING ENHANCED NETWORK COVERAGE IN A WIRELESS NETWORK

(71) Applicants: Paul Nicholas Senior, Bicester (GB); Masayoshi Son, Tokyo (JP); Eric Donald Stonestrom, Palm Beach, FL (US)

(72) Inventors: Paul Nicholas Senior, Bicester (GB); Masayoshi Son, Tokyo (JP); Eric Donald Stonestrom, Palm Beach, FL (US)

(21) Appl. No.: 15/499,131

(22) Filed: Apr. 27, 2017

(51) Int. Cl. H04W 16/26; H04W 16/28; H04L 5/00

(52) U.S. Cl. CPC H04W 16/26; H04W 88/085; H04L 5/0035; H04W 16/28

(57) ABSTRACT

An apparatus and method are described for providing enhanced network coverage in a wireless network. The apparatus has a first antenna system for providing a first sector of a network, and a second antenna system for providing a second sector of the network. Further, the apparatus has a third antenna system for communicating with a base station of the network to provide a common wireless backhaul link for the first sector and the second sector. The first and the second antenna systems are configured such that when the apparatus is deployed at a periphery of a building, the first sector extends into the building to provide enhanced availability of the network to items of user equipment within the building, whilst the second sector extends externally to the building to provide an additional source of network coverage to items of user equipment external to the building. Through the use of such an apparatus, it has been found that significant improvements in network coverage can be readily obtained, and further the overall spectral efficiency of the network can be enhanced to improve network capacity.

### BACKGROUND

The present technique relates to an apparatus and method for providing enhanced network coverage in a wireless network.

As more and more users embrace mobile technology, this is placing ever increasing demands on the mobile networks used to support mobile communication. The networks are required to not only support an ever increasing number of devices, but also as the functionality associated with such devices becomes ever more complex, so this has also increased the capacity requirements within the network.

Accordingly, there is a need for network operators to provide increased network coverage, but also to improve network capacity so as to service the high performance demands placed upon the network by users of modern smartphones and the like.

The problems of providing sufficient network coverage and capacity can be particularly problematic in urban environments, where there is typically not only a high density of users, but where the urban infrastructure, such as large buildings, can significantly attenuate signals, and hence exacerbate the problem of seeking to provide sufficient network coverage and network capacity to service the users. Accordingly, it would be desirable to provide techniques that enabled coverage and capacity to be improved.

### SUMMARY

In one example configuration, there is provided an apparatus comprising: a first antenna system to provide a first sector of a network; a second antenna system to provide a second sector of the network; and a third antenna system to communicate with a base station of the network to provide a common wireless backhaul link for said first sector and said second sector; wherein the first and the second antenna systems are configured such that when the apparatus is deployed at a periphery of a building, the first sector extends into the building to provide enhanced availability of the network to items of user equipment within the building, and the second sector extends externally to the building to provide an additional source of network coverage to items of user equipment external to the building.

In another example configuration, there is provided a method of operating an apparatus having first, second and third antenna systems to provide network coverage in a wireless network, comprising: employing the first antenna system to provide a first sector of a network; employing the second antenna system to provide a second sector of the network; employing the third antenna system to communicate with a base station of the network to provide a common wireless backhaul link for said first sector and said second sector; and configuring the first and the second antenna systems such that when the apparatus is deployed at a periphery of a building, the first sector extends into the building to provide enhanced availability of the network to items of user equipment within the building, and the second sector extends externally to the building to provide an additional source of network coverage to items of user equipment external to the building.

In a yet further example configuration, there is provided an apparatus comprising: first antenna means for providing a first sector of a network; second antenna means for providing a second sector of the network; and third antenna means for communicating with a base station of the network to provide a common wireless backhaul link for said first sector and said second sector; wherein the first and the second antenna means are configured such that when the apparatus is deployed at a periphery of a building, the first sector extends into the building to provide enhanced availability of the network to items of user equipment within the building, and the second sector extends externally to the building to provide an additional source of network coverage to items of user equipment external to the building.

### BRIEF DESCRIPTION OF THE DRAWINGS

The present technique will be described further, by way of example only, with reference to embodiments thereof as illustrated in the accompanying drawings, in which:

FIG. 1 is a block diagram schematically illustrating an apparatus in accordance with one embodiment;

FIG. 2 illustrates how the apparatus of the described embodiments creates indoor and outside sectors in accordance with one embodiment;

FIG. 3 illustrates how users may connect to the network using the apparatus of the described embodiments;

FIG. 4 schematically illustrates how improved spectral efficiency may be achieved when an item of user equipment connects to the network via the apparatus of the described embodiments;

FIG. 5 is a block diagram illustrating in more detail functionality provided within the apparatus in accordance with one embodiment; and

FIGS. 6A and 6B illustrate the arrangement of antenna elements within the apparatus in accordance with one embodiment.

### DESCRIPTION OF EMBODIMENTS

Before discussing the embodiments with reference to the accompanying figures, the following description of embodiments is provided.

In one embodiment, an apparatus is provided that has a first antenna system for providing a first sector of a network and a second antenna system for providing a second sector of the network. The apparatus is arranged to communicate with a base station of the network via a third antenna system, the third antenna system providing a common wireless backhaul link for the first sector and the second sector.

The first and the second antenna systems are arranged so that when the apparatus is deployed at a periphery of a building, the first sector provided by the first antenna system extends into the building to provide enhanced availability of the network to items of user equipment within the building. However, in addition the second sector extends externally to the building to provide an additional source of network coverage to items of user equipment external to the building.

Modern telecommunications Standards, such as the Long-Term Evolution (LTE) Standard, allow for high-speed wireless communication with items of user equipment. However, the signals propagated from the base stations typically do not have good indoor penetration. By placing the above described apparatus at a periphery of a building, a good quality link can typically be established via the third antenna system to a base station of the network, with the use of the first antenna system then allowing for a first sector of coverage to be established that extends into the building to provide enhanced availability of the network inside the building.

However, in addition, in urban environments it is also often the case that items of user equipment in the open environment, for example belonging to users moving around at street level between buildings, can experience poor connectivity. In particular, pockets of poor network coverage may develop, and even in areas where there is network coverage, the link quality established with the base station may be relatively poor, resulting in reduced bit rates observed by the item of user equipment, and a less efficient utilisation of the available network spectrum. This reduces not only the quality of the service observed by certain users, but also can degrade the overall spectral efficiency of the network.

However, in accordance with the above described apparatus, the same apparatus that is used to create a first sector that extends into the building to provide enhanced availability of the network to items of user equipment within the building, is also able to re-radiate network coverage externally to the building, by use of the second antenna system to provide an additional, second, sector for the network. Accordingly, items of user equipment external to the building are now provided with a further connection option for connecting into the network. In particular, whilst it is still possible that they may connect directly to a macro base station of the network, when they are present within the geographical coverage area covered by the second sector they can instead connect to the network via the second antenna system of the apparatus, with the third antenna system then being used to provide a backhaul connection into the network for those users (along with users connected via the first antenna system).

This provides significantly enhanced flexibility, and can also give rise to significant spectral efficiency improvements within the network. In particular, the apparatus can be configured to provide a high quality backhaul communication link to the base station of the network, and in addition can provide high quality connections for items of user equipment residing within the first sector and the second sector. This can lead to the establishment of high performance links that can employ efficient modulation schemes to make more efficient use of the available spectrum, when compared with a situation where those items of user equipment instead establish a direct connection to the macro base station of the network. As a result, the overall spectral efficiency of the network can be increased.

The apparatus of the described embodiments may be positioned externally to the building at the periphery, for example by being mounted on an exterior wall of the building, but in one embodiment the apparatus is deployed inside the building at the periphery, in which event the second antenna system is configured to generate at least one beam pattern that propagates through the periphery to facilitate communication with at least one item of user equipment within the second sector. If desired, directional antennas can be used to generate a beam pattern that radiates in a desired direction externally to the building. For example, this second antenna system may be arranged so as to radiate a beam pattern that will ensure good coverage for users at street level. Alternatively, or in addition, the beam pattern created by the second antenna system may cause the second sector to extend across a street into an adjacent building, so that items of user equipment within that adjacent building may be able to connect into the network via the apparatus.

In situations where the apparatus is deployed inside the building at the periphery, the third antenna system may also be configured to generate at least one beam pattern that propagates through the periphery to provide the common wireless backhaul link. Again, directional antennas can be used if desired, to seek to improve the quality of the connection with the base station of the network, and thereby enhance the capacity of the common wireless backhaul link.

The apparatus can be deployed in a variety of locations, but in one embodiment is intended to be deployed adjacent to a window at the periphery of the building. In one particular embodiment, the apparatus is shaped so as to facilitate placement on a windowsill. This can provide a very convenient location for the apparatus, where it does not get in the way of users going about their business inside the building, and where it is likely that a strong connection with the base station of the network can be established.

By providing an apparatus that can be easily deployed within a building, this can provide a very cheap and efficient mechanism for a network operator to rapidly increase network coverage, whilst also facilitating improved spectral efficiency, and thereby enhancing the capacity of the network.

In a typical deployment, both the second antenna system and the third antenna system will be transmitting and receiving signals in a similar direction. For example, in one embodiment, they will both generate beam patterns that propagate through the periphery of the building, so that the second antenna system can establish the second sector of the network external to the building, and so that the third antenna system can communicate with the base station of the network external to the building to provide a common wireless backhaul link. In one embodiment, an isolation control mechanism can be employed to seek to isolate signals processed by the third antenna system from at least the signals processed by the second antenna system. This serves to reduce any interference between the signals processed by the third antenna system and the second antenna system, thereby improving overall performance. If desired, the isolation control mechanism can also seek to isolate signals processed by the third antenna system from the signals processed by the first antenna system, but in one embodiment the first antenna system is configured to generate a beam pattern that radiates in a direction substantially opposite to the direction used for the wireless backhaul link, and hence specific isolation control mechanisms may not be required in respect of the first antenna system.

The isolation control mechanism can take a variety of forms, but in one embodiment comprises one or more of: frequency control circuitry to operate the third antenna system to process signals at a frequency different to the frequency of signals processed by the second antenna system; filtering circuitry to applying filtering and/or interference cancellation operations to inhibit coupling between antenna elements of the second antenna system and antenna elements of the third antenna system; and/or positioning of the antenna elements of the second antenna system relative to the antenna elements of the third antenna system to inhibit interaction between the second antenna system and the third antenna system.

By use of filtering/interference cancellation operations, and careful positioning of the antenna elements of the second antenna system relative to the antenna elements of the third antenna system, it is possible to provide sufficient isolation between the second and third antenna systems, whilst allowing those antenna systems to use similar, albeit different, frequencies. In particular, one embodiment can allow the second antenna system and the third antenna system to operate at different frequencies within the same frequency band. Hence, considering an embodiment where the network uses LTE communication, this can allow the same band to be used for providing LTE access to items of end user equipment via the first and second sectors, whilst also being used for providing LTE backhaul connectivity to the local base station of the network in order to provide the common wireless backhaul link. This enables very efficient use of the available spectrum by enabling the common backhaul communication to be provided in-band.

In one embodiment, the apparatus may further comprise a sector management mechanism to inhibit interaction between signals propagated within the first sector and signals propagated within the second sector. By limiting interference between the first and second antenna systems, this can increase the overall capacity provided by the first and second sectors.

The sector management mechanism can take a variety of forms, but in one embodiment comprises at least one of: use of directional antenna elements within the first antenna system and the second antenna system to produce beam patterns such that the first sector and the second sector are substantially non-overlapping; and provision of a signal attenuating barrier located within the apparatus between the first antenna system and the second antenna system. In particular, by using directional antenna elements, it can be ensured that the first and second sectors are essentially non-overlapping. Further, in one embodiment the first and second antenna systems can be mounted on opposite sides of a support structure that operates as a signal attenuating barrier to thereby further reduce interaction between the two antenna systems.

However, due to the reflections of signals that can take place whilst those signals are propagating within the first and second sectors, there is still a possibility that signals propagating within the second sector may be reflected in such a manner that they propagate into the first sector, and vice versa. For instance, one particular source of such reflections may be the periphery of the building, for example the window discussed earlier.

However, in one embodiment, such reflections can be used constructively by the apparatus through the provision of coordination control circuitry that is arranged to coordinate signal handling by the first and second antenna systems to provide coordinated multipoint communication within at least one of the first and second sectors. In particular, in one embodiment both the first antenna system and the second antenna system are arranged to operate using the same frequency channel, i.e. they operate at the same frequency, and by using the coordination control circuitry, it is possible to alleviate co-channel interference between the indoor and outdoors sectors. In particular, in such instances reflections from structures such as the window can be used constructively to actually improve performance. In particular, in the presence of such potential interference, the coordination control circuitry can be arranged to coordinate the operations of the first and second antenna systems, such that both antenna systems are used to communicate simultaneously with a particular item of user equipment in order to improve the spectral efficiency of that communication relative to a situation where only a single one of the antenna systems is used and signals from the other antenna system are allowed to introduce a source of interference to that communication.

There are a number of known coordinated multipoint (CoMP) communication techniques that can be used. For example, the concepts for CoMP have been the focus of various studies by 3GPP for the LTE Advanced Telecommunications Standard. However, in accordance with the described apparatus, the coordinated multipoint techniques are applied specifically in relation to the configuration of the back-to-back first and second antenna systems, that essentially propagate communications in opposite directions to establish the first and second sectors. This can simplify the techniques required, and in particular in one embodiment the coordinated multipoint communication techniques chosen are not restricted to particular versions of LTE, making them generally applicable within any LTE network. Further, it will be appreciated that the present techniques are not restricted to use in any particular telecommunications network. For example, whilst in the described embodiments the LTE Advanced Telecommunications Standard will be referred to, the techniques could also be applied in telecommunications systems employing different Standards, for example the 5G New Radio (NR) Standard.

In one embodiment, when employing the coordinated multipoint communication for downlink transmission from the apparatus to an item of user equipment, the first and second antenna systems are arranged to utilise non-coherent joint transmission. In accordance with this technique, both the first antenna system and the second antenna system are used to simultaneously transmit data to an item of user equipment within either the first sector or the second sector in order to improve the received signal quality and/or data throughput.

In one embodiment, when employing the coordinated multipoint communication for uplink reception by the apparatus of a signal transmitted from an item of user equipment, the first and second antenna systems are arranged to employ a joint reception mechanism. Joint reception is essentially a diversity scheme that combines usage of the receiver chains of the first and second antenna systems of the apparatus for uplink communications from an item of user equipment, so as to seek to maximise signal to noise ratio.

By arranging the apparatus to operate in the above described configuration, where it provides separate indoor and outdoor sectors, with a shared common wireless backhaul link to a base station, the apparatus is hence viewed differently by different components within the network. In particular, the base station that the apparatus connects to via the common wireless backhaul link is a macro base station of the network. Based on its communication with the macro base station via the third antenna system, the apparatus is viewed as an item of user equipment by the macro base station. Conversely, for the items of user equipment that connect to the apparatus via either the first antenna system or the second antenna system, the apparatus is viewed as merely a further base station of the network. Whilst from the macro base station's point of view the apparatus will be viewed as another item of user equipment being connected into the network, and thus might be considered to potentially further impact network capacity issues, as discussed earlier it has been found that through the provision of such an apparatus, the apparatus can provide a number of items of user equipment with a much more efficient route for connecting into the network, rather than those items of user equipment connecting directly to a macro base station. As a result, the overall spectral efficiency of the network can be improved, since for example better modulation techniques can be used to make more efficient use of the available spectrum.

The first, second and third antennas systems can be arranged in a variety of ways, but in one embodiment each of those three antenna systems comprise an array of antenna elements, which are configured in a manner to allow an increase in spectral efficiency of the network when items of user equipment connect to the network via the apparatus rather than connecting directly to a macro base station of the network.

In particular, since the apparatus is not a handheld device like normal items of user equipment, it is not constrained by size and power factors that would typically constrain the antennas within such handheld user devices. Instead, in one embodiment the array of antenna elements used in at least one of the first, second and third antenna systems have characteristics allowing a more efficient modulation of signals than is possible using the antenna system of an item of user equipment connecting to the apparatus.

These characteristics can take a variety of forms, but in one embodiment comprise one or more of: more antenna elements within the array than is provided within the item of user equipment; larger sized antenna elements within the array than the antenna elements within the item of user equipment; the antenna elements are operated with higher power than the antenna elements within the item of user equipment; and/or the antenna elements are configured to provide higher gain than the antenna elements within the item of user equipment. As a result, the apparatus can typically establish a stronger, higher performance, link with the macro base station than would typically be possible by items of equipment seeking to connect directly to the macro base station. Further, those items of user equipment may also be able to establish stronger, higher performance, links with the apparatus via the first and/or second antenna systems, than the connection that they could make with a macro base station of the network. These two factors combined then provide a very spectrally efficient mechanism for connecting those items of user equipment into the network via the above described apparatus.

Particular embodiments will now be described with reference to the Figures.

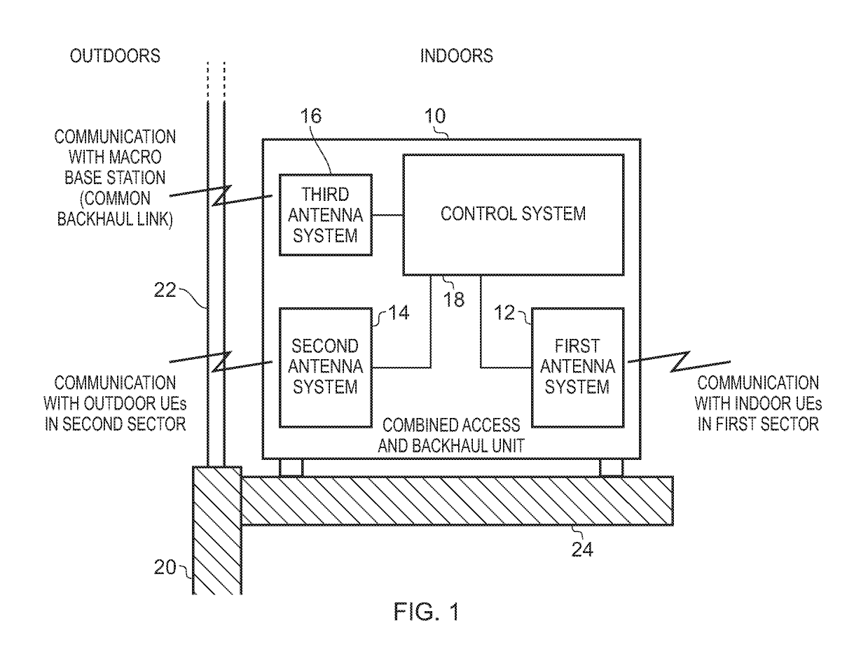

FIG. 1 schematically illustrates an apparatus 10 as used in the described embodiments. Herein, the apparatus will also be referred to as a combined access and backhaul unit. As shown, the combined access and backhaul unit 10 may in one embodiment be positioned adjacent to a periphery 20, 22 of a building. In one particular embodiment, it is located on a windowsill 24 adjacent to a window 22 at the periphery of the building.

The combined access and backhaul unit 10 has a number of distinct antenna systems. In particular, a first antenna system is used to provide a first sector of the network that extends into the building so as to provide enhanced availability of the network to items of user equipment within the building. To access the network for any items of user equipment that connect via the first antenna system, it is necessary to connect the apparatus 10 into the network. This is achieved through use of the third antenna system 16, which is arranged to establish a backhaul link with a base station of the network. Since such a base station will typically be provided externally to the building, the third antenna system is arranged to generate at least one beam pattern that propagates through the window 22 to establish a wireless backhaul link with the base station.

Modern telecommunications Standards, such as the LTE Standard, allow for high-speed wireless communication with items of user equipment. However, the signals propagated from the base stations typically do not have good indoor penetration. By placing the apparatus 10 at a periphery of a building, a good quality link can typically be established via the third antenna system to a base station of the network, with the use of the first antenna system 12 then allowing for a first sector of coverage to be established that extends into the building to provide enhanced availability of the network inside the building.

However, in addition, in urban environments it is also often the case that items of user equipment in the open environment, for example belonging to users moving around at street level between buildings, can experience poor connectivity. For example, pockets of poor network coverage may develop, due to shadowing from buildings and the like, and even in areas where there is network coverage, the link quality established with the base station may be relatively poor. This can result not only in reduced quality of service observed by certain users, but also can degrade the overall spectral efficiency of the network due to the less efficient utilisation of the available network spectrum that can result from use of such poor quality links.

To address this problem, the combined access and backhaul unit 10 provides an additional antenna system, namely the second antenna system 14, which provides a second sector of the network, the second antenna system generating at least one beam pattern that propagates through the periphery 22 to facilitate communication with at least one item of user equipment external to the building. Hence, through use of the second antenna system, the combined access and backhaul unit 10 can re-radiate network coverage externally to the building, such that items of user equipment external to the building and falling within the coverage area of the second sector are now provided with a further connection option for connecting into the network.

For any users that connect to the apparatus 10 via either the first antenna system or the second antenna system, then the third antenna system is used to provide a common wireless backhaul link back into the network. By such an approach, it is possible to establish good quality links with items of user equipment in both the first and second sectors, through use of the respective first and second antenna systems. In combination with a good quality backhaul link provided by the third antenna system to a macro base station of the network, this can result in the various items of user equipment connected to the network via the apparatus 10 being provided with higher quality links into the network, allowing for more efficient use of the available network spectrum when compared with a situation where those items of user equipment instead establish a direct connection to a macro base station of the network. As a result, the overall spectral efficiency of the network can be increased.

It should be noted that if desired the apparatus 10 could be mounted externally to the building at the periphery, in which case the first antenna system would generate at least one beam pattern that propagates through the periphery into the building, whilst the second and third antenna systems' beam patterns would no longer need to propagate through the periphery. However, for the following description of embodiments, it will be assumed that the apparatus 10 is provided internally at the periphery of the building. This can enable a reduction in the cost of the apparatus, by avoiding the need to weatherproof the housing, and also provides for significantly simplified deployment. In one particular embodiment, the apparatus 10 is shaped so that it can readily be placed on a windowsill or the like within the building, this providing a very convenient location where it does not get in the way of users going about their business inside the building, and where it is likely that a strong connection with the base station of the network can be established.

Each of the antenna systems 12, 14, 16 will include not only an array of antenna elements used to transmit and receive the RF signals, but also the associated RF stage circuit elements that process the transmitted and received RF signals. In addition, each of the antenna systems will have associated baseband stage (i.e. digital signal processing stage) circuits for processing the transmit signals prior to them being converted into RF signals, and to process received signals after they have been converted from RF signals into baseband signals. These baseband stage circuits can be considered to be provided as part of the antenna system blocks 12, 14, 16, or may be considered to be part of the associated control system 18 that controls the operation of the various antenna systems, and the interactions between them. The control system 18 will provide all of the required control functionality for the different antenna systems, as well as controlling the routing of signals between the antenna systems so that signals received via the first and second antenna systems from items of user equipment can be routed through the third antenna system over the backhaul link to the network, and conversely signals to be propagated to those items of user equipment that are received over the backhaul link by the third antenna system can be routed to the appropriate first and second antenna systems for transmission to the required items of user equipment.

It should be noted that FIG. 1 is not intended to illustrate how the various components are laid out within the combined access and backhaul unit 10, but instead is merely a schematic illustration of the different antenna systems and associated control system. By way of example, whilst the third antenna system 16 is shown above the second antenna system 14, in one embodiment the second and third antenna systems are actually placed side by side, and hence when considering the vertical elevation view of the apparatus 10 as shown in FIG. 1, one of the second and third antenna systems would reside behind the other.

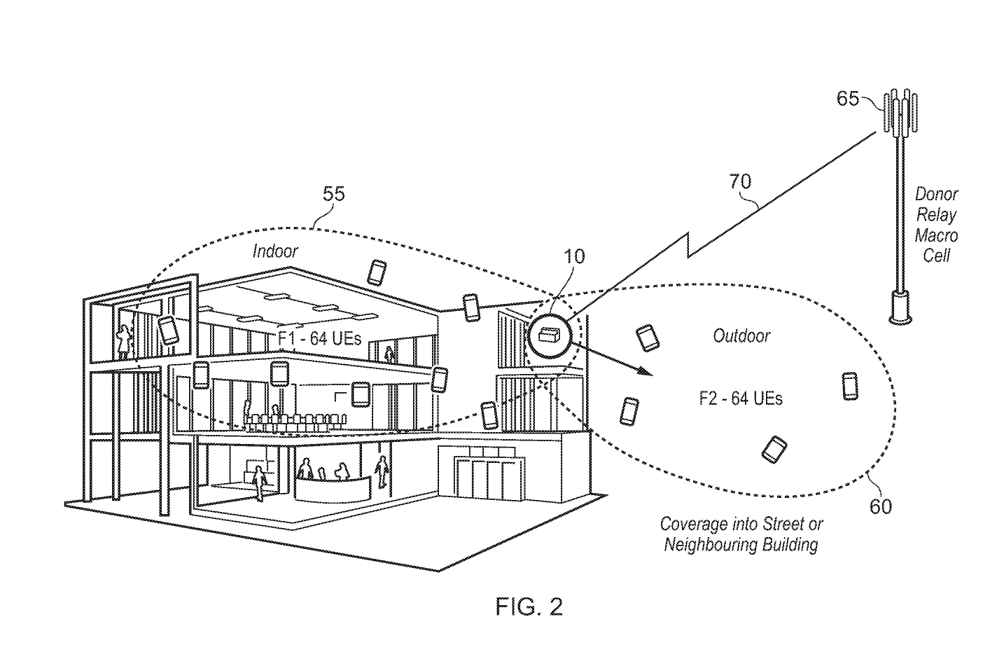

FIG. 2 schematically illustrates how the apparatus 10 may be used to establish both indoor and outdoor sectors for connection of items of user equipment. In particular, as shown, the combined access and backhaul unit 10 can be arranged to produce a first sector 55 of coverage through the beam pattern(s) employed by the first antenna system, and in addition can create an outdoor sector of coverage 60 through the beam pattern(s) deployed by the second antenna system 14. A common wireless backhaul link 70 can then be established by the third antenna system 16 communicating with a macro base station 65, also referred to herein as a donor relay macrocell, or a donor eNodeB (DeNB).

The first, second and third antenna systems can be arranged in a variety of ways, but in one embodiment each of those three antenna systems comprises an array of antenna elements, which are configured in a manner to allow an increase in spectral efficiency of the network when items of user equipment connect to the network via the apparatus 10 rather than connecting directly to a macro base station such as the illustrated base station 65. Since the apparatus is not a handheld device like normal items of user equipment, it is not constrained by size and power factors that would typically constrain the antennas within such handheld user devices. Hence, the array of antenna elements used in the various first, second and third antenna systems can be provided with characteristics that allow a more efficient modulation of signals than may be possible using the antenna system of an item of user equipment connecting to the apparatus 10.

For example, more antenna elements may be provided within each of the arrays, those antenna elements can be of a larger size, the antenna elements may be operated with higher power, and/or may be configured to provide higher gain, than would typically be the case for antenna elements within handheld items of user equipment. As a result, it has been found that a significant number of items of user equipment can connect to each combined access and backhaul unit 10, whilst providing good quality links into the network through the common wireless backhaul link 70. This can lead to a significant increase in the overall spectral efficiency of the network when compared with the situation where each of those items of user equipment individually connected to a macro base station of the network, for example by allowing more efficient modulation schemes to be used for the communications. In one embodiment up to 128 items of user equipment may be connected into each combined access and backhaul unit 10, and as schematically illustrated in FIG. 2 this could for example allow 64 items of user equipment to connect via the indoor sector 55 and another 64 items of user equipment to connect via the outdoor sector 60.

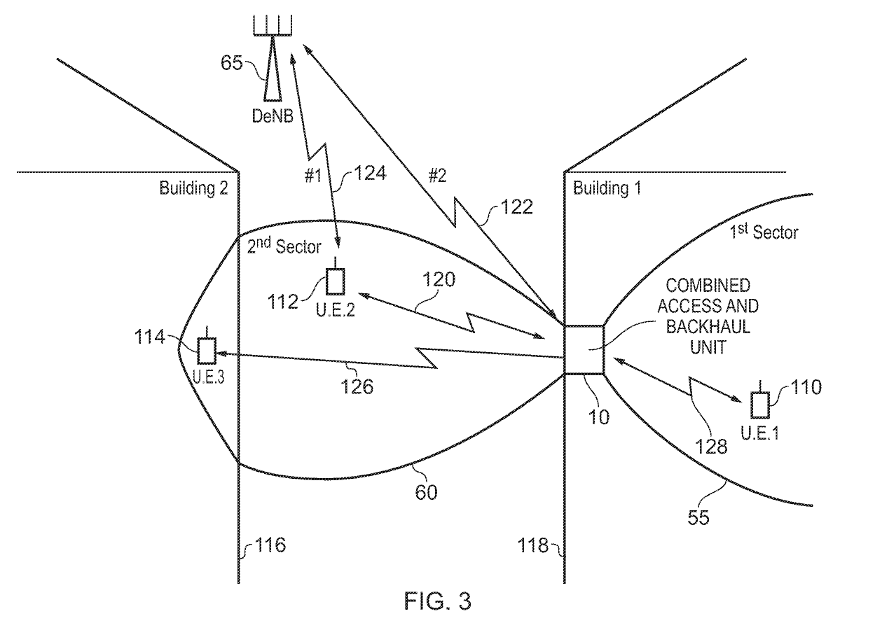

FIG. 3 schematically illustrates an urban environment in which a combined access and backhaul unit 10 is located on a windowsill in a first building 118, that first building 118 being positioned opposite to an adjacent building 116. External to both buildings a donor eNodeB (DeNB) 65 is provided to form a macro base station of the network. The combined access and backhaul unit 10 creates a first sector 55 of coverage through use of the first antenna system, and a second sector 60 of coverage that propagates into the open space external to the building. As schematically shown in FIG. 3 the second sector may in one embodiment extend far enough that it permeates inside the second building 116.

Considering first the item of user equipment 112 that is being operated externally to both buildings, this item of user equipment may have the option to connect directly to the donor eNodeB 65 as illustrated schematically by the communication path 124. However, through the provision of the combined access and backhaul unit 10, it also has the option to connect into the network via the unit 10, and in particular can establish a connection 120 with the second antenna system. If this route is taken, then the connection into the network will occur through the combination of the communication link 120 and the common backhaul link 122 provided by the third antenna system.

In some instances, it may be the case that the quality of the connection between the item of user equipment 112 and the second antenna system of the combined access and backhaul unit 10 is better than the quality of the communication link 124, and as a result the item of user equipment 112 may decide to connect to the unit 10, rather than directly to the donor eNodeB 65. For instance, the link 120 may allow a more efficient modulation scheme to be used than would be the case for the link 124. Provided a high performance backhaul link 122 can also be provided, then overall an improvement in spectral efficiency may be achieved by the item of user equipment 112 connecting into the network via the paths 120, 122, rather than directly over path 124.

It should be noted that this benefit may also be available to the item of user equipment 114 within the second building 116, in situations where that item of user equipment falls within the coverage area of the second sector 60. Accordingly, it may choose to access the network via the communication link 126 with the second antenna system 14, with the unit 10 then completing the connection into the network via the common backhaul link 122. In particular, due to the relative location of the second building 116 and the donor eNodeB 65, it may be that the item of user equipment 114 only obtains a relatively poor connection directly to donor eNodeB 65, whereas it may be able to make a higher quality connection 126 with the combined access and backhaul unit 10.

As also shown in FIG. 3, an item of user equipment 110 within the first sector 55 may connect into the donor eNodeB 65 via the combined access and backhaul unit 10, using a communication link 128 to the first antenna system, and with the unit 10 then using the common wireless backhaul link 122 to connect that item of user equipment 10 into the network.

In one embodiment, the frequency channel (i.e. frequency) used for communicating over the wireless backhaul link 122 is the same as the frequency channel used when items of user equipment connect directly to the donor eNodeB, and hence the same frequency channel will also be used for a connection made via path 124. However, the frequency channel used for communications between items of user equipment and the first and second antenna systems 12, 14 may in one embodiment be a different frequency channel to the frequency channel used for the communication links 122, 124. This can serve to mitigate interference between the communications within the first and second sectors 55, 60 using the first and second antenna systems 12, 14, and the communication links with the macro base station. However, in one embodiment, it is possible for all of these communication links to be provided within the same frequency band, hence allowing in-band access and backhaul links to be established.

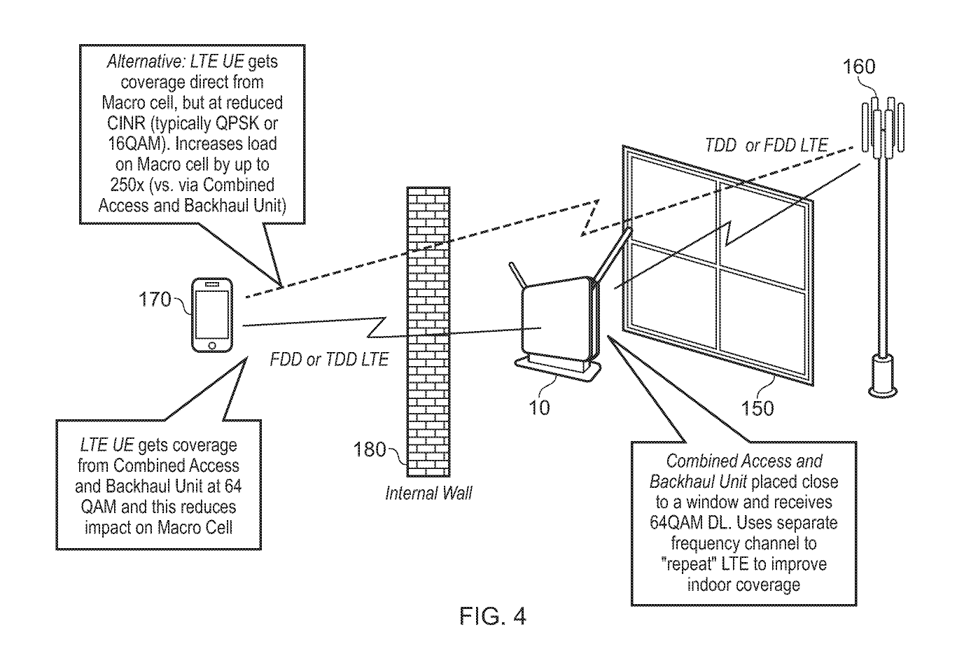

FIG. 4 schematically illustrates how the use of the combined access and backhaul unit 10 can improve the overall quality of the connection for an item of user equipment. In this example, an indoor scenario is considered, where the unit 10 establishes a backhaul communication link with the macro base station 160 through the window 150. It is assumed here that an item of user equipment 170 within the building has the possibility of making a direct connection with the macro base station 160, but that various attenuating factors such as the internal wall 180, the window 150, etc, mean that the direct link is of a relatively poor quality, hence requiring relatively inefficient modulation schemes such as QPSK or 16QAM to be used. However, it is assumed that the wireless backhaul link can use a much more efficient modulation scheme such as 64QAM, and that similarly that more efficient modulation scheme can also be used for communications between the unit 10 and the item of user equipment 170. As a result, it is more spectrally efficient for the item of user equipment 170 to connect to the macro base station 160 via the combined access and backhaul unit 10, since through this connection method there is less overall impact on the macro cell, and hence overall spectral efficiency of the network can be increased.

It has been found that the use of the combined access and backhaul unit 10 can improve the spectral efficiency of the network in many situations, but provides particularly enhanced improvements in spectral efficiency and user equipment performance when deployed in the middle to outer regions of a coverage area of a macrocell provided by a DeNB.

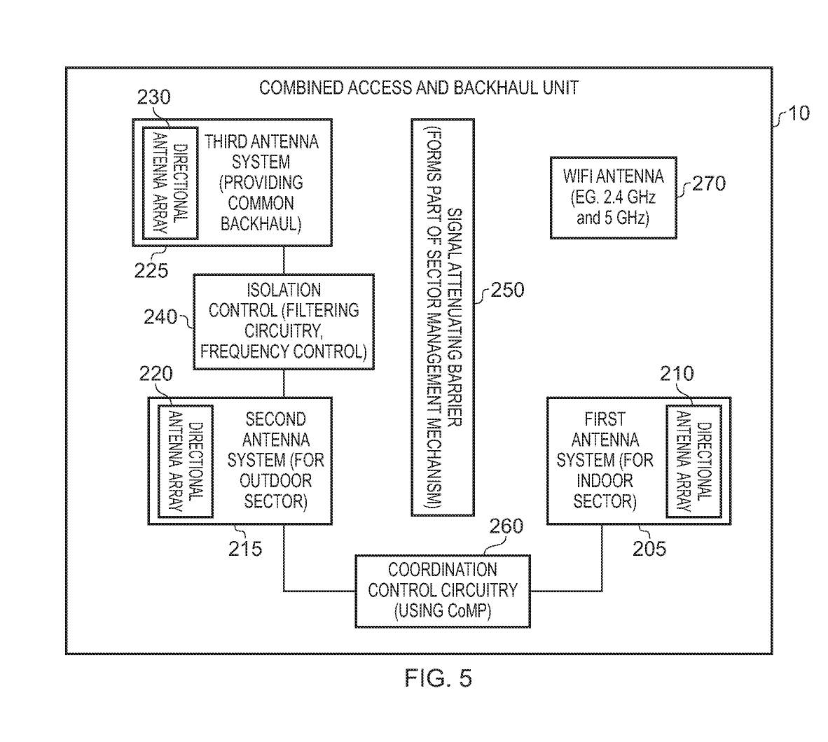

FIG. 5 is a block diagram illustrating in more detail some of the functionality that may be provided within the combined access and backhaul unit 10 in accordance with some embodiments. Firstly, each of the first, second and third antenna systems 205, 215, 225 may be provided with a directional antenna array 210, 220, 230, etc, so that beams can be generated in a manner that seeks to reduce interference between the signals being processed by the separate antenna systems.

However, it will be appreciated that even when directional antenna arrays are used, the beams generated by the second and third antenna systems 215, 225 will generally be propagating in the same direction, and hence it is possible for there to be interference between the signals processed by the second and third antenna systems. In one embodiment, to alleviate this effect, one or more isolation control mechanisms can be used to seek to isolate the signals processed by the third antenna system 225 from the signals processed by at least the second antenna system 215, and if desired also the first antenna system 205.

As one of the isolation control mechanisms, the third antenna system can be arranged to operate at a slightly different frequency to the second antenna system. However, it can be desirable for the frequency channel used for the third antenna system to be quite close to the frequency channel used by the second antenna system, since in one embodiment this can allow the second and the third antenna systems to operate at different frequencies within the same frequency band. In such an arrangement, additional isolation control mechanisms 240 can also be implemented so as to further isolate the two antenna systems from each other. In particular, in one embodiment, filtering circuitry may be added to apply filtering and/or interference cancellation operations to inhibit coupling between antenna elements of the second antenna system and antenna elements of the third antenna system. One example of a suitable technique would be bulk acoustic wave filtering, which may be used in the case where the frequency channel of the backhaul link provided by the third antenna system is different to the frequency channel used for communications using the first and second antenna systems providing the first and second sectors. As an alternative, full duplex interference cancellation techniques can be used, for example in the case where the second and third antenna systems use the same frequency channel.

In addition, or alternatively, the antenna elements of the second antenna system can be carefully positioned relative to the antenna elements of the third antenna system in order to reduce interaction between the antenna systems. Through use of such filtering/interference cancellation and/or positioning techniques, it is possible to provide sufficient isolation between the second and third antenna systems, whilst allowing those antenna systems to use similar, albeit different, frequencies.

As mentioned earlier, in one embodiment both the first and second antenna systems 205, 215 operate on the same frequency channel. In one embodiment, one or more sector management mechanisms can be employed to inhibit interaction between signals propagated within the first sector and signals propagated within the second sector. By seeking to limit interference between the first and second antenna systems, this can increase the overall capacity provided by the first and second sectors, for example by allowing simultaneous communication with an item of user equipment in the first sector using the first antenna system, and communication with a second item of user equipment in the second sector using the second antenna system.

The sector management mechanism can take a variety of forms, but in one embodiment the use of the two different directional antenna arrays 210, 220 can be used as a first sector management mechanism, since it enables beam patterns to be produced such that the first sector and the second sector are substantially non-overlapping. In addition, the components of the first and second antenna systems can be positioned within the unit so that they are separated by a signal attenuating barrier 250, which can also be considered to form part of the sector management mechanism. In one particular embodiment, the first and second antenna systems 205, 215 can be mounted on opposite sides of a support structure that operates as a signal attenuating barrier to thereby further reduce interaction between the two antenna systems.

However, even when such sector management systems are used, it is still possible for there to be some interference between the first and second antenna systems. In particular, due to the reflections of signals that can take place whilst those signals are propagating within the first and second sectors, it is still possible that signals propagating within the second sector may be reflected in such a manner that they propagate into the first sector, and vice versa. For instance, one particular source of such reflections may be the periphery of the building, for example the window 22 discussed earlier.

In one embodiment, when such sources of interference are detected, the reflections can be used constructively through the provision of the coordination control circuitry 260 shown in FIG. 5. In particular, the coordination control circuitry 260 can be arranged to coordinate signal handling by the first and second antenna systems 205, 215 to provide coordinated multipoint (CoMP) communication within at least one of the first and second sectors. Such a mechanism can alleviate co-channel interference between the indoor and outdoor sectors, and indeed in such instances reflections from structures such as the window can be used constructively to actually improve performance.

For example, in the presence of such potential interference, the coordination control circuitry can be arranged to coordinate the operations of the first and second antenna systems, such that both antenna systems are used to communicate simultaneously with a particular item of user equipment in order to improve the spectral efficiency of that communication. Whilst this may cause a reduction in the number of items of user equipment that can be communicated to simultaneously, it can significantly increase the quality of the communications with individual items of user equipment.

There are a number of known CoMP communication techniques that can be used. For example, LTE CoMP provides a range of different techniques that are being developed for the LTE Advanced telecommunications Standard, that enable the dynamic coordination of transmission and reception over a variety of different base stations. Essentially, LTE Advanced CoMP turns the inter-cell interference (ICI) into useful signals, especially at the cell borders where performance may be degraded.

More details of such techniques can be found in a variety of papers, see for example the Technical Report 3GPP TR 36.819 V11.1.0 (2011-12) entitled “3rd Generation Partnership Project; Technical Specification Group Radio Access Network; Coordinated Multi-Point Operation for LTE Physical Layer Aspects (Release 11) (available at http:/www.qtc.ip/3GPP/Specs/36819-b10.pdf).

However, in accordance with the described embodiments, the coordinated multipoint techniques are applied specifically in relation to the configuration of the back-to-back first and second antenna systems, that essentially propagate communications in opposite directions to establish the first and second sectors. This can simplify the techniques required, and in particular in one embodiment the coordinated multipoint communication techniques chosen are not restricted to particular versions of LTE, making them generally applicable within any LTE network. Further, as mentioned earlier, the techniques could also be applied in telecommunications systems employing different Standards, for example the 5G New Radio (NR) Standard.

In one particular embodiment, when employing the coordinated multipoint communication for downlink transmission from the apparatus to an item of user equipment, the first and second antenna systems are arranged to utilise non-coherent joint transmission. In accordance with this technique, both the first antenna system and the second antenna system are used to simultaneously transmit data to an item of user equipment within either the first sector or the second sector in order to improve the received signal quality and/or data throughput.

In contrast, in one embodiment, when employing the coordinated multipoint communication for uplink reception by the apparatus of a signal transmitted from an item of user equipment, the first and second antenna systems are arranged to employ a joint reception mechanism. Joint reception is essentially a diversity scheme that combines usage of the receiver chains of the first and second antenna systems 205, 215 for uplink communications from an item of user equipment, so as to seek to maximise signal to noise ratio.

When operating the apparatus 10 in the manner described herein, where it provides separate indoor and outdoor sectors, with a shared common wireless backhaul link to a base station, the apparatus is viewed differently by different components within the network. In particular, based on the unit's communications with the macro base station 65 via the third antenna system, the unit 10 will be viewed as an item of user equipment by the macro base station. Conversely, for the items of user equipment that connect to the unit 10 via either the first antenna system or the second antenna system, the unit 10 is viewed as merely a further base station of the network.

Whilst from the macro base station's point of view, the unit 10 will be viewed as another item of user equipment being connected into the network, and thus might be considered to potentially further impact network capacity issues, as discussed earlier the unit can provide a number of items of user equipment with a much more efficient route for connecting into the network, rather than those items of user equipment connecting directly to a macro base station. As a result, the overall spectral efficiency of the network can be improved.

The first, second and third antenna systems can be arranged so as to enhance the spectral efficiency improvements achievable. In one embodiment, each of those three antenna systems comprise an array of antenna elements which are configured in a manner to allow an increase in spectral efficiency of the network when items of user equipment connect to the network via the unit 10 rather than connecting directly to a macro base station of the network.

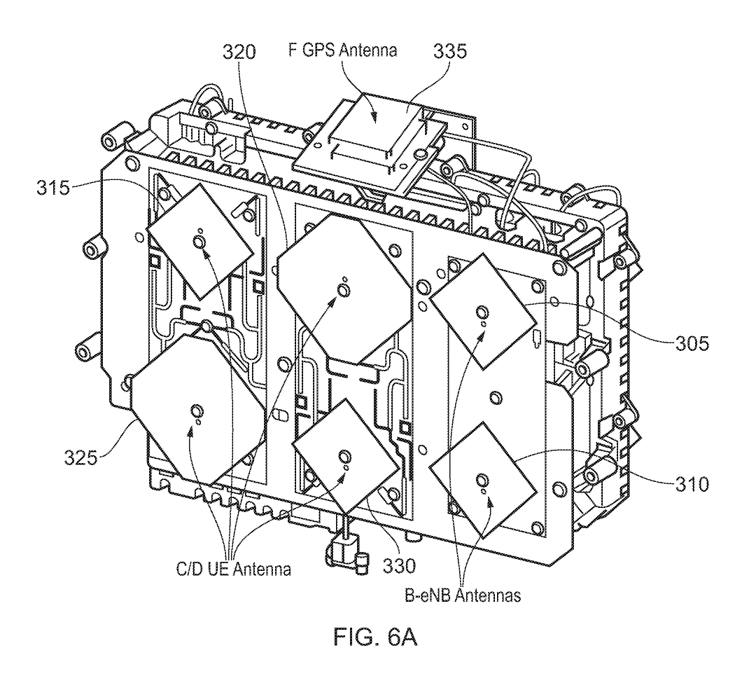

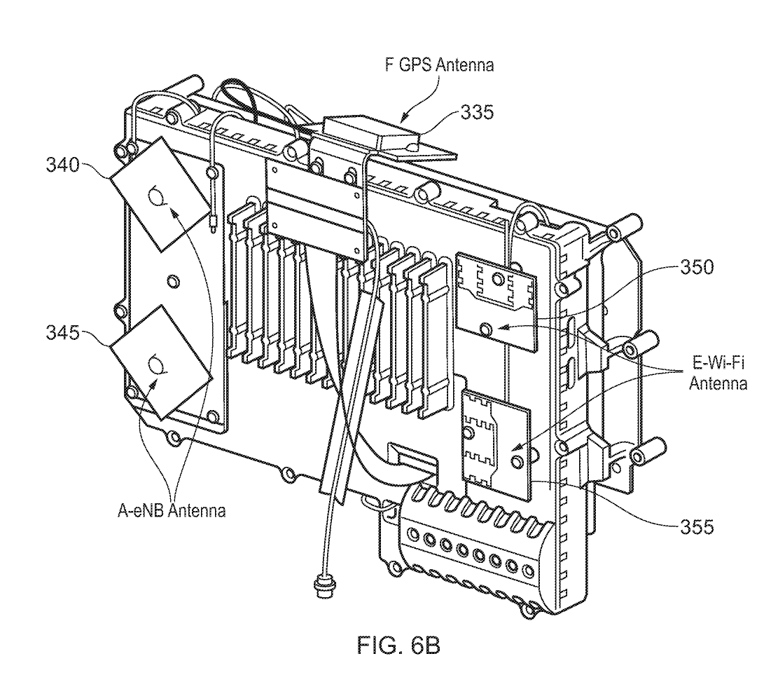

FIGS. 6A and 6B illustrate the arrangement of antenna elements within each of the antenna systems in accordance with one embodiment. Considering first FIG. 6A, the two antenna elements 305, 310 form the antenna array of the second antenna system used to provide the second sector of coverage. Further, as shown in FIG. 6A, the array of antenna elements 315, 320, 325, 330 are used to form the antenna array of the third antenna system to provide the common wireless backhaul link to the macro base station. The larger antenna elements 320, 325 enable multiple band operation for the backhaul link, and allow connections across many frequency bands that the mobile carrier may have in operation.

FIG. 6B shows the same unit, but from the opposite side to that shown in FIG. 6A, and shows the two antenna elements 340, 345 that may be used to form the antenna array of the first antenna system 12 used to provide the first sector. As also shown, if desired the apparatus can provide a Wi-Fi access point through use of one or more Wi-Fi antennas 350, 355. This can provide a useful additional functionality, by enabling internet connectivity to any Wi-Fi equipped phone, computer or device as and when required.

As also shown in FIGS. 6A and 6B, an outwardly facing GPS antenna 335 can be provided if desired. The GPS antenna can provide timing and location information, and the particular configuration shown in FIGS. 6A and 6B can optimize the position of the GPS receiver 335 and associated ground plane to maximise performance through a window. This hence improves the likelihood of being able to obtain a GPS signal at the apparatus, and hence be able to obtain the above-mentioned GPS timing and location functionality.

Since the unit 10 is not a handheld device like normal items of user equipment, it is not constrained by size and power factors that would typically constrain the antennas within such handheld user devices. Hence, the various antenna elements shown for the three different antenna systems can be arranged to be relatively large, and indeed more antenna elements may be provided than may be possible in some handheld devices. Further, those antenna elements can be operated with higher power than would typically be possible with antenna elements within an item of user equipment, and/or the antenna elements may be configured to provide higher gain than the antenna elements within typical handheld items of user equipment. This hence enables stronger, higher performance, links to be established, both with the macro base station to establish the common wireless backhaul link, and with the individual items of user equipment that connect to the unit 10, rather than connecting directly back to a macro base station. This then enables a very spectrally efficient mechanism to be provided for connecting items of user equipment into the network via the unit 10.

Through use of the combined access and backhaul unit 10, it will be appreciated that a number of significant benefits are realised. In particular, the ready provisioning of such a unit at a suitable indoor location adjacent a periphery of a building, for example on a windowsill, can provide extensive network extension for public communication networks such as LTE, providing both indoor and outdoor coverage improvement and capacity enhancement, including coverage into adjacent buildings without the need to deploy any infrastructure into those adjacent buildings.

In one embodiment the same frequency band can be used for both “LTE access” and “LTE UE relay” (i.e. the common wireless backhaul link) without requiring the implementation of 3GPP “LTE Relay” functionality on either the donor macro cell or the combined access and backhaul unit. The 3GPP “LTE Relay” functionality is described for example in the Technical Report 3GPP TR 36.806 V9.0.0 (1010-03) entitled “Third Generation Partnership Project; Technical Specification Group Radio Access Network; Evolved Universal Terrestrial Radio Access (E-UTRA); Relay architectures the E-UTRA (LTE-Advanced) (Release 9).

The use of such a combined access and backhaul unit 10 as described in the above embodiments can enable delivery of a large coverage footprint both indoors and outdoors by enabling the use of multiple directional antennas and much higher EIRP (Effective Isotropic Radiated Power) than traditionally supported, whilst still meeting all of the key SAR and ICNRP RF safety requirements. It has been found that aggregate indoor and outdoor coverage typically exceeds 4000 sqm in most deployments.

The use of such a combined access and backhaul unit enables good indoor coverage at higher frequency bands like 2.× GHz and 3.× GHz, which normally suffer from poor capacity and coverage performance within buildings.

The described technique also improves overall network spectral efficiency, by removing items of user equipment from connections that consume LTE resource blocks using lower modulation and coding schemes (MCS), and instead promoting these items of user equipment to connections that use higher order MCS, by arranging them to connect to the network through the combined access and backhaul unit. This can provide significant “relay gain”, typically up to 30 dB.

As discussed earlier, the combined access and backhaul unit can use higher performance UE technology and higher gain antennas. Smartphones cannot practically use UE technology with a large number of high gain receive and transmit antennas because of size constraints and typically have lower gain, multi-band antennas. Within the combined access and backhaul unit it is possible to use antennas that are much larger and band specific, which deliver between 15 and 25 dB gain over typical modern smartphones.

Further, through use of the earlier described CoMP mechanisms, the combined access and backhaul unit 10 is able to use dual co-channel (high gain) eNB sectors (the first and second sectors provided by the first and second antenna systems) that operate without self-interference. Overlapping coverage and reflections from the window and the like can actually improve the performance of both the indoor and/or indoor to outdoor coverage.

Further, by using the earlier discussed isolation control mechanisms, including both filtering/interference cancellation techniques and careful antenna placement to reduce the adjacent channel interference, this enables the use of the same frequency band for providing LTE access to items of end user equipment and connectivity to the local LTE donor macro cells for backhaul.

In one embodiment, the form factor of the combined access and backhaul unit 10 can be designed to fit the majority of windowsills to enable simple widespread deployment, and propagation in both directions including the rear facing “outdoor” sector which can provide coverage to users externally to the building, and indeed users in adjacent buildings.

In one embodiment, the combined access and backhaul unit 10 is arranged to operate in Band 41, between 2496 MHz and 2690 MHz.

In the described embodiments, the combined access and backhaul unit 10 can provide public access to all LTE items of user equipment within the coverage area of the first and second sectors. The system is not closed, and is open to any user subscribed to the carrier network.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although particular embodiments have been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

1. An apparatus comprising:
a first antenna system to provide a first sector of a network;
a second antenna system to provide a second sector of the network; and
a third antenna system to communicate with a base station of the network to provide a common wireless backhaul link for said first sector and said second sector;
wherein the first and the second antenna systems are configured such that when the apparatus is deployed at a periphery of a building, the first sector extends into the building to provide enhanced availability of the network to items of user equipment within the building, and the second sector extends externally to the building to provide an additional source of network coverage to items of user equipment external to the building.

2. An apparatus as claimed in claim 1, wherein when the apparatus is deployed inside the building at said periphery, the second antenna system is configured to generate at least one beam pattern that propagates through said periphery to facilitate communication with at least one item of user equipment within said second sector.

3. An apparatus as claimed in claim 2, wherein the third antenna system is also configured to generate at least one beam pattern that propagates through said periphery to provide the common wireless backhaul link.

4. An apparatus as claimed in claim 2, wherein the apparatus is deployed adjacent to a window at said periphery.

5. An apparatus as claimed in claim 4, wherein the apparatus is shaped so as to facilitate placement on a windowsill.

6. An apparatus as claimed in claim 1, further comprising an isolation control mechanism to seek to isolate signals processed by the third antenna system from at least the signals processed by the second antenna system.

7. An apparatus as claimed in claim 6, wherein said isolation control mechanism comprises one or more of:
frequency control circuitry to operate the third antenna system to process signals at a frequency different to the frequency of signals processed by the second antenna system;
filtering circuitry to applying filtering and/or interference cancellation operations to inhibit coupling between antenna elements of the second antenna system and antenna elements of the third antenna system;
positioning of the antenna elements of the second antenna system relative to the antenna elements of the third antenna system to inhibit interaction between the second antenna system and the third antenna system.

8. An apparatus as claimed in claim 7, wherein the second antenna system and third antenna system operate at different frequencies within a same frequency band.

9. An apparatus as claimed in claim 1, further comprising a sector management mechanism to inhibit interaction between signals propagated within the first sector and signals propagated within the second sector.

10. An apparatus as claimed in claim 9, wherein said sector management mechanism comprises at least one of:
use of directional antenna elements within the first antenna system and the second antenna system to produce beam patterns such that the first sector and the second sector are substantially non-overlapping; and
provision of a signal attenuating barrier located within the apparatus between the first antenna system and the second antenna system.

11. An apparatus as claimed in claim 1, further comprising coordination control circuitry to coordinate signal handling by the first and second antenna systems to provide coordinated multipoint communication within at least one of the first and second sectors.

12. An apparatus as claimed in claim 11, wherein the periphery of the building introduces a source of signal reflections, and the coordination control circuitry is arranged to constructively utilise said signal reflections.

13. An apparatus as claimed in claim 11, wherein when employing the coordinated multipoint communication for downlink transmission from the apparatus to an item of user equipment, the first and second antenna systems are arranged to utilise non-coherent joint transmission.

14. An apparatus as claimed in claim 11, wherein when employing the coordinated multipoint communication for uplink reception by the apparatus of a signal transmitted from an item of user equipment, the first and second antenna systems are arranged to employ a joint reception mechanism.

15. An apparatus as claimed in claim 1, wherein:
the base station is a macro base station of the network;
the apparatus is viewed, based on its communication with the macro base station via the third antenna system, as an item of user equipment by the macro base station, and is viewed as a further base station of the network by items of user equipment that connect to the apparatus via one of the first antenna system and the second antenna system.

16. An apparatus as claimed in claim 15, wherein each of the first, second and third antenna systems comprise an array of antenna elements, which are configured in a manner to allow an increase in spectral efficiency of the network when items of user equipment connect to the network via the apparatus rather than connecting directly to a macro base station of the network.

17. An apparatus as claimed in claim 16, wherein the array of antenna elements used in at least one of the first, second and third antenna systems have characteristics allowing a more efficient modulation of signals than is possible using the antenna system of an item of user equipment connecting to the apparatus.

18. An apparatus as claimed in claim 17, wherein said characteristics comprise one or more of:
more antenna elements within the array than is provided within the item of user equipment;
larger sized antenna elements within the array than the antenna elements within the item of user equipment;
the antenna elements are operated with higher power than the antenna elements within the item of user equipment;
the antenna elements are configured to provide higher gain than the antenna elements within the item of user equipment.

19. A method of operating an apparatus having first, second and third antenna systems to provide network coverage in a wireless network, comprising:
employing the first antenna system to provide a first sector of a network;
employing the second antenna system to provide a second sector of the network;
employing the third antenna system to communicate with a base station of the network to provide a common wireless backhaul link for said first sector and said second sector; and
configuring the first and the second antenna systems such that when the apparatus is deployed at a periphery of a building, the first sector extends into the building to provide enhanced availability of the network to items of user equipment within the building, and the second sector extends externally to the building to provide an additional source of network coverage to items of user equipment external to the building.

20. An apparatus comprising:
first antenna means for providing a first sector of a network;
second antenna means for providing a second sector of the network; and
third antenna means for communicating with a base station of the network to provide a common wireless backhaul link for said first sector and said second sector;
wherein the first and the second antenna means are configured such that when the apparatus is deployed at a periphery of a building, the first sector extends into the building to provide enhanced availability of the network to items of user equipment within the building, and the second sector extends externally to the building to provide an additional source of network coverage to items of user equipment external to the building.
